(19) United States
(12) Patent Application Publication
(10) Pub. No.: US 2019/0052640 A1
(43) Pub. Date: Feb. 14, 2019

(54) DEVICE, SYSTEM AND METHOD FOR PROTECTING NETWORK DEVICES

(71) Applicant: Terafence Ltd, Haifa (IL)

(72) Inventors: Yehezkel EREZ, Haifa (IL); Ayal AVRECH, Haifa (IL); Naftaly SHARIR, Zichron Yaakov (IL)

(73) Assignee: Terafence Ltd, Haifa (IL)

(21) Appl. No.: 16/154,776

(22) Filed: Oct. 9, 2018

Related U.S. Application Data
(63) Continuation of application No. 15/276,873, filed on Sep. 27, 2016, now abandoned.

(51) Int. Cl. H04L 29/06

(52) U.S. Cl. CPC H04L 63/10; H04L 63/0227; H04L 63/0209; H04L 63/20

(57) ABSTRACT

A unidirectional secured network adapter to receive an at least one communication from an at least one device of plurality of devices of the secure network over an unsecured communication protocol which include a privilege data. The unidirectional secured network adapter writes the privilege data in a memory, converts the privilege data from first parallel. data stream to serial data stream and passes the serial data stream through an isolation unit, converts the serial data stream of the privilege data to a second parallel data stream and writes the privilege data in a read only memory. The unidirectional secured network adapter applies an unsecured communication protocol to the privilege data and transmits the privilege data to at least one device of the unsecured network.

### CROSS REFERENCE TO RELATED APPLICATIONS

This Application is a continuation of application Ser. No. 15/276,873 filed on Sep. 27, 2016.

### BACKGROUND OF THE INVENTION

Nowadays, sensors are widely used to measure and provide data to an application that may control an entity or an operation such as, for example, an air conditioner of a house, a battery consumption of a phone, a fuel control of an engine, the maneuvering of an airplane (e.g., automatic pilot), a security system, etc. Sensors may also measure human body parameters, such as for example, blood pressure heart rate, temperature, blood sugar level, etc.

The sensors may be of different types and may transmit their data over unsecured networks, for example wireless public network such as, cellular networks, WiFi, etc.

Thus, the sensors and the data may be exposed to malicious attacks from devices of the unsecure network, for example breach the security of a secure system, harm the operation of cars, interfere with the operation airplane or do unauthorized use of private and privileged data of the sensors.

### BRIEF DESCRIPTION OF THE DRAWINGS

The subject matter regarded as the invention is particularly pointed out and distinctly claimed in the concluding portion of the specification. For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The specification, however, both as to organization and method of operation, together with objects, features, and advantages thereof, may best be understood by reference to the following detailed description when read with the accompanying drawings in which:

FIG. 1 is a schematic block diagram illustration of a data communication system, in accordance with some demonstrative embodiments;

FIG. 2 is a schematic illustration of a circuitry to provide a secured one direction communication, in accordance with some demonstrative embodiments;

FIG. 3 is a schematic flow-chart illustration of a method of a secured one direction communication, in accordance with some demonstrative embodiments; and

FIG. 4 is a schematic flow-chart illustration of another method of a secured one direction communication, in accordance with some demonstrative embodiments.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “exemplary embodiments”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The term “SerDes” or “serdes”, as used herein, may include a Serializer/Deserializer data convertor. For example, serdes may include a pair of functional blocks to convert data between serial data and parallel interfaces in each direction.

The term “module” as used herein, may include hardware and/or software and/or any combination of software and hardware. For example, a memory module may be, but not limited to, a hardware unit configured to store data, instructions, information, measurement values etc. Protocol module may be, but not limited to a combination of hardware and software configured to encapsulate and/or decapsulation communications, data and the like. Some protocol modules may include memory buffer, if desired.

Some embodiments may be used in conjunction with various networks and systems, for example, communication networks, Internet, telephone network, computer networks, sensors networks, cable network, wireless networks, cellular networks, local area networks (LAN), wireless LAN, wide area networks (WAM), wireless AN and the like.

Demonstration embodiments may include a circuitry, for example an integrated circuit, a system on chip, a hybrid integrated circuit, an electronic circuit on a printed board and the like.

Logic, modules, devices and interfaces herein described may perform functions that may be implemented in hardware and/or code. Hardware and/or code may comprise software, firmware, microcode, processors, state machines, chipsets, or combinations thereof designed to accomplish the functionality.

A demonstrative embodiment may include, for example, a secured unidirectional network adapter. The secured unidirectional network adapter may prevent, for example, devices of an unsecured network from maliciously attacking devices of a secured network.

According to some example embodiments, devices of the unsecured network may include computers, laptop computers, smartphones, tablets, computer based devices, network devices and the like. Devices of the secured network may include sensors, computer base devices, internet of things (IoT), based devices, robots, Radio Frequency Identification (RFID), and the like. The sensors may include a pressure sensor, an ultrasonic sensor, a humidity sensor, gas leakage sensor, a motion sensor, an acceleration sensor, a displacement sensor, a force measurement sensor, a color sensor, a gyro sensor, medical sensors such as, for example blood pressure sensor, heart bits sensor or the like.

According to sonic demonstrative embodiments, the secured network may include, but is not limited to, a firewall, a unidirectional network segment or the like. For example, the unidirectional network may also be referred to as a unidirectional security gateway or data diode, and is a network appliance and/or device allowing data to travel only in one direction through the unidirectional network segment, used in guaranteeing information security. The unidirectional network may serve as connections between two or more networks of differing security classifications. A firewall is a network security system that monitors and controls the incoming and outgoing network traffic based on predetermined security rules. The firewall may establish a barrier between a trusted, secure internal network and another outside network, such as the Internet, that is assumed not to be secure or trusted. Network firewalls are a software appliance running on general purpose hardware or hardware-based firewall computer appliances that filter traffic between two or more networks. Host-based firewalls provide a layer of software on one host that controls network traffic in and out of that single machine. Firewall appliances may act as a Dynamic Host Configuration Protocol (DHCP) or virtual private network (VPN) server for internal network, if desired.

According to some exemplary embodiments, the secured unidirectional network adapter may be connected to the secure network at one end and to the unsecured network at the other end. Communications from sensors of the secured network may be carried out in a protocol that may be converted by the secured unidirectional network adapter and be transferred through a physical unidirectional isolation unit to devices of the unsecured network. On the other end, communications from the devices of the unsecured network may be blocked by the secured unidirectional network adapter from access to the secured network, if desired.

It should be understood that the embodiment described above is by way of example only, and other embodiments may be used.

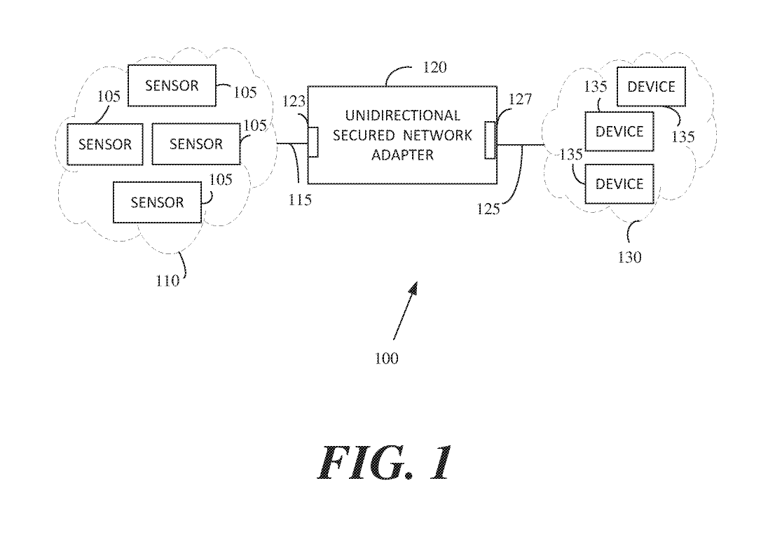

Reference is made to FIG. 1, which schematically illustrates a block diagram illustration of a data communication system 100, in accordance with some demonstrative embodiments. According to some unlimited embodiments, for example, data communication system 100 may include a secured network 110 comprising a plurality of sensors 105, a unidirectional secured network adapter 120, an unsecured network 130 comprising a plurality of devices 135.

In some embodiments, for example, unidirectional secured network adapter 120 may be connected to secured network 110 by a connector 123, for example a Registered Jack (RJ)-45 standard connector, and to unsecured network by a connector 127, for example RJ-45 standard connector. The RJ-45 connector may be used, in some embodiments, to connect unidirectional secured network adapter 120 to the Ethernet.

In other embodiments, unsecure network 130 may include wireless network, and the connection to unidirectional secured network adapter 120 may be done wirelessly, if desired. Furthermore, for example secured network 110 may include wireless sensors and/or devices, and the connection to unidirectional secured network adapter 120 may be done wirelessly, if desired.

It should be understood that, according to the above describe unlimited exemplary embodiments, unidirectional secured network adapter 120 may include wire network interface, wireless network interface and/or a combination of both.

In operation, unidirectional secured network adapter 120 may receive at least one communication 115 from secured network 110. For example, communication 115 may include privilege data of at least one of sensors 105. Communication 115 may be delivered over a secured communication protocol, if desired.

For example, the secured communication protocols may include Health Insurance Portability and Accountability Act (HIPPA) related protocols, Internet Protocol version 6 (IPv6) over Low power Wireless Personal Area Networks (6LoWPAN), Message Queue Telemetry Transport (MQTT), serial over Transmission Control Protocol (TCP), Constrained Application Protocol (CoAP) runs over UDP, Controller Area Network (CAN) bus tor cars and the like.

According to some demonstrative embodiments, unidirectional secured network adapter 120 may receive an at least one communication 125 from an at least one device of plurality of devices of an unsecure network according to an unsecured communication protocol. For example, the unsecured communication protocol may include TCP/Internet Protocol (IP), Dynamic Host Configuration Protocol (DHCP), User Datagram Protocol (UDP), Datagram Congestion Control Protocol (DCCP), Resource Reservation Protocol (RSVP) or the like.

Unidirectional secured network adapter 120, for example, may prevent, by using software, hardware and/or combination of software and hardware, communication 125 from reaching device 105, e.g., desktop computer of unsecure network 130, from accessing any device 105, e.g., sensor, of secured network 110. Unidirectional secured network adapter 120, for example, may convert the secured protocol to an unsecured communication protocol and may permit the communication from secured network 110 to pass to the at least one device 135 of the plurality of devices of unsecured network 130 over the unsecured protocol if desired.

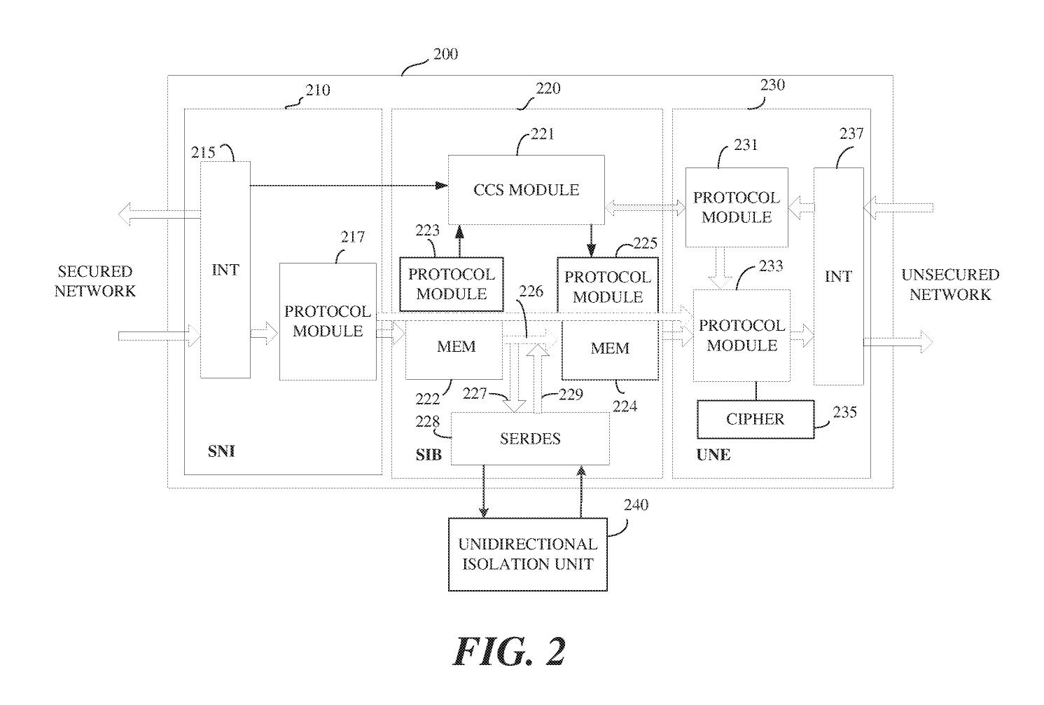

Reference is made to FIG. 2, which schematically illustrates circuitry 200 adapted to provide a secured unidirectional communication, in accordance with some demonstrative embodiments. According to some demonstrative embodiments, circuitry 200 may include a Secured Network Ingress (SNI) logic 210, Secured Interconnection Bridge (SIB) logic 220, Unsecured Network Egress (UNE) logic 230 and a unidirectional isolation unit 240.

For example, SNI 210 may include a network interface 215 and first protocol module 217. SIB 220 may include a control, configuration and status (CCS) module 221, a first memory unit 222, a second protocol module 223, a second memory unit 224, a third protocol module 225 and a serdes unit 228. UNE 230 may include a fourth protocol module 231, a fifth protocol module 233, a cipher module 235 and a network interface 237.

According to some exemplary embodiments, circuitry 200 may be implemented by a hardware, a software and/or any combination of hardware and software. For example, circuitry 200 may be implemented on an Application-specific integrated circuit (ASIC), a system on chip (SoC) and/or on a programmable device such as, for example field-programmable gate array (FPGA).

First and second memory units 222 and 224 may comprise a storage medium such as Dynamic Random Access Memory (DRAM), read only memory (ROM), buffers, registers, cache memory, flash memory, hard disk drive, solid-state drive, or the like.

In some embodiments, circuitry 200 may perform a protective bi-directional operation, bridging between an unsecured network (e.g., the Internet) and secured protected network (e.g., sensors network). For example, circuitry 200 may be configured to operate in a low power consumption mode, if desired. For example, circuitry 200 may include three operational modes, a normal operation mode, a low power operation mode and a sleep mode. In the normal operation mode, circuitry 200 may operate at continuous high networking speed, which may result a power consumption up to, but not limited to 1 Watt. In the low power mode, circuitry 200 may operate at burst-type communication at low network rate, e.g., 10 Mbps or less. The power consumption may be less than, but not limited to 0.1 Watt while active, but not limited to. Circuitry 200 may enter into the sleep mode when there is no networking traffic at the low-power mode. In sleep mode the power consumption may be less than 10 mWatt, although not limited too.

According to some example embodiments, network interface 237 of UNE 230 may support an incoming multilayer link, data and application protocols such as, for example Ethernet UDP, TCP/IP, IPv6 and the like. For example, fourth protocol module 231 may decapsulate, comply, maintain and properly terminate at least some connections with the unsecured networks. In one embodiment, cipher module 235 may encrypt privilege data received from the secured network, and fifth protocol module 233 may encapsulate the encrypted data and network interface 237 may transmit the encrypted data to the unsecured network. In another embodiment, the privilege data is not encrypted, and network interface 237 may transmit unencrypted privilege data to the unsecured network.

According to additional embodiments, for example, network interface 237 may include a wireless network interface. For example, the wireless network interface may support different wireless standards such as, for example, WiFi, Bluetooth®, Long Term Evolution (LTE), LTE Advance, and the like

SNI 210 may communicate with the secured network. For example, network interface 215 may support services and communication stack protocols such as, for example, Supervisory Control And Data Acquisition (SCADA), 6LoWPAN, MQTT serial over TCP, CoAP over UDP, CAN, etc., to establish the communication with sensors at the secured side, to keep and manage the configuration and device hooks for future security tasks, and to define the bandwidth profile per sensor type and needs, if desired.

For example, network interface 215 may support communication with a plurality of devices, e.g., up to 250 devices, connected to the secured network and/or a secured bus, and may maintain devices configuration and status. First protocol module 217 may provide necessary protocol-dependent services such as, for example, DHCP for TCP/IP, may dynamically support the addition or removal of field devices at the secured side, and may decapsulate communications received from the secured network with privilege data, although it should be understood that this is a non-limiting example embodiment.

According to some demonstrative embodiments, SIB 220, for example, may act as a secured uni-directional data bridge between SNI 210 and UNE 230. SIB 220 may ensure that the devices attached to the secured network may be isolated from any access initiated from the unsecured networks. Communication initialized from the secured network may be reformatted, adapted and verified to comply with a desired criterion, then transferred toward the unsecured network by a desired communication protocol.

Furthermore, CCS module 221 may manage a control plan communication and may register a relevant control and status information for the devices which are attached to the secured network. For example, the privilege data may be stored in first memory 222. Second protocol module 223 may encapsulate the privilege data and may transfer the privilege data to serdes unit 228. Serdes unit 228 may convert parallel privilege data to a serial privilege data and transfer the serial data through unidirectional isolation unit 240.

According to some demonstrative embodiments, unidirectional isolation unit 240 may include, for example, an opto-coupler isolator, a magnetic coupler isolator, an acoustic coupler isolator or the

According to some demonstrative embodiments, the serial data from unidirectional isolation unit 240 may be converted to parallel data by serdes unit 228. The parallel privileged data may be stored in memory 224 and may be decapsulated by third protocol module 225, if desired,

The data flow as described herein above may be done to ensure one direction data flow, in double protection. For example, the double protection may include a physical separation of memory buffers, e.g., first and second memories 222 and 224, and a unidirectional serial bus with opto-coupler isolator, e.g., unidirectional isolator unit 240, to provide the double protection one way optical transmission.

According to some embodiments, for example, first memory 222 may be addressed by UNE 230 with a read operation only. UNE 230 may communicate CCS module 221 to read the content of memory 224. UNE 230 may not have physical access to a write control line of memory 224 and/or to a write control line of memory 222. CCS module 221 may route in a way that enable the UNE 230 to activate the read control line of memory 224. SIB 220 and/or SNI 210 may control first memory 222 and may perform write operations on first memory 222 and read only in case of transferring data to memory 224.

According to some demonstrative embodiments, data may flow between memories 222 to memory 224 rather by parallel or serial bus/connection. For example, a Parallel data bus connection 226. CCS module 221 may control first and second memories 222 and 224 to provide one-way data transfer between memories 222 and 224, if desired. A serial one direction connection from first memory 222 to second memory 224 may be done by a bus 227 serdes unit 228, unidirectional unit 240 and a bus 229, if desired.

In some demonstrative embodiments, SIB 220 may incorporate error detection algorithm and error correction algorithm to secure the one way data transmission in, for example, high probability of 10 in power of −16 loss rate. Additionally, CCS module 221 may provide a configuration for the installation and future communication to ensure identification and authentication for secured communications. CCS module 221 may include a status memory (not shown) for reporting and telemetry. SIB 220 may transfer outgoing data and/or information to UNE 230. For example, the outgoing data and/or information may be transmitted in UDP and/or TCP/IP protocols, if desired.

Advantageously, circuitry 200 may allow access from the secured network to parameters related to and/or reflecting status, big data information, telemetry and configuration collected at the secured side, with a very high security level.

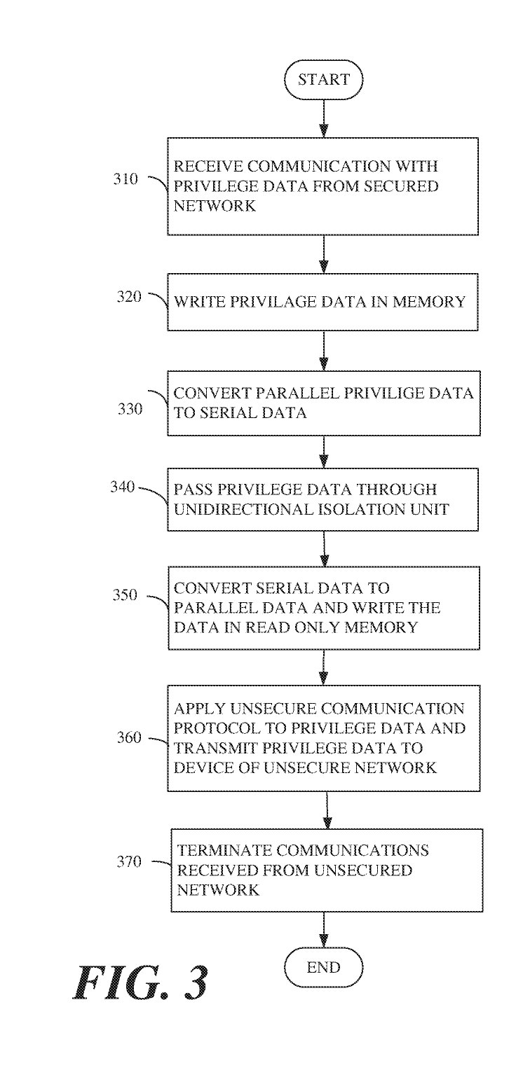

Reference is made to FIG. 3, which schematically illustrates a flow-chart of a method of a secured one direction communication between a secured network and an unsecured network, in accordance with some demonstrative embodiments. For example, circuitry 200, e.g., a secured unidirectional network adapter, may receive an at least one communication with a privilege data from an at least one device of plurality of devices of the secured network e.g. secured network 110 of FIG. 1, (text box 310). Circuitry CCS module 221 of circuitry 200 may write the privilege data in a memory e.g. first memory unit 222 (text box 320).

According to sonic demonstrative embodiments, for example, serdes unit 228 of circuity 200 may convert the privilege data from first parallel data stream to serial data stream (text box 330) and may pass the serial data stream through unidirectional isolation unit 240 for example a photo diode (text box 340).

Serdes unit 228 may convert the serial data stream of the privilege data to a second parallel data stream and write the privilege data in a read only memory, e.g., second memory 224 (text box 350). UNE 230 may apply an unsecured communication protocol to the privilege data and may transmit the privilege data to at least one device of an unsecured network, e.g., unsecured network 130 (text box 360), and may terminate communications received from the unsecured network 130 (text box 370).

According to one example embodiment, the privilege data may be encrypted. For example, cipher unit 235 may encrypt the privilege data intended to devices of unsecured network. It should be understood that this is an example only, and with some embodiments the privilege data may be transmitted to the unsecured network without being encrypted.

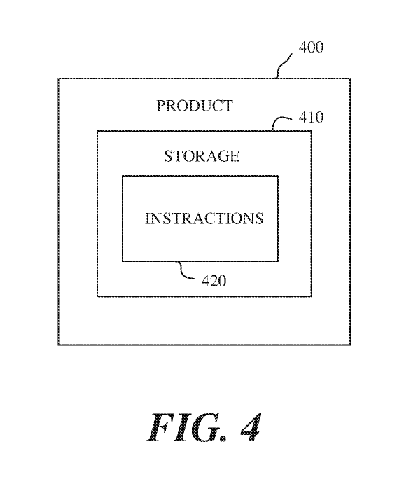

Reference is made to FIG. 4, which schematically illustrates a product of manufacture 400, in accordance with some demonstrative embodiments. Product 400 may include a non-transitory machine-readable storage medium 410 to store logic 420, which may be used, for example, to perform at least part of the functionality of device 120 (FIG. 1) and/or to perform one or more operations of the method of FIG. 3. The phrase “non-transitory machine-readable medium” is directed to include all computer-readable media, with the sole exception being a transitory propagating signal.

In some demonstrative embodiments, product 400 and/or machine-readable storage medium 410 may include one or more types of computer-readable storage media capable of storing data, including volatile memory, non-volatile memory, removable or non-removable memory, erasable or non-erasable memory, writeable or re-writeable memory, and the like. For example, machine-readable storage medium 410 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a hard drive, an optical disk, a magnetic disk, a card, a magnetic card, an optical card, and the like. The non-transitory computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 420 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 420 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++. Java, BASIC, Matlab, Pascal, Visual BASIC, assembly language, machine code, and the like.

### EXAMPLES

The following examples pertain to further embodiments.

Example 1 includes a method to transfer communications between a secured network and an unsecured network, the method comprising: receiving an at least one communication from an at least one device of plurality of devices of the secure network over a first communication protocol wherein the at least one communication includes privilege data; writing the privilege data in a first memory; converting the privilege data from first parallel data stream to serial data stream and pass the serial data stream through an isolation unit; converting the serial data stream of the privilege data to a second parallel data stream and writing the privilege data in a second memory; applying an unsecured communication protocol to the privilege data; and transmitting the privilege data to at least one device of the unsecured network, wherein transmissions from the plurality of devices of the unsecured network to the secured side are terminated by the circuitry.

Example 2 includes the subject matter of Example 1 and optionally, wherein the first memory cannot be accessed by the plurality of devices of the unsecure network.

Example 3 includes the subject matter of Example 1 and Example 2 and optionally, the method comprising: transmitting an at least one communication to the at least one device of the unsecured network to terminate connection with the at least on device.

Example 4 includes the subject matter of Examples 1 to 3, and optionally, the method comprising: converting by a protocol convertor unit the first communication protocol to a second communication protocol, the second communication protocol is being selected from at least two or more communication protocols.

Example 5 includes the subject matter of Examples 1 to 4, and optionally the circuitry comprises: a first logic to process the communications from the secured network; a second logic to communicate with the unsecured network; and a third logic to physically block communications from the unsecured network and to provide the modified secured data the second logic.

Example 6 includes the subject matter of Examples 1 to 5, and optionally the circuitry comprises a secured unidirectional network adaptor.

Example 7 includes the subject matter of Examples 1 to 6, and optionally the isolation unit comprises a unidirectional circuitry to transfer the modified secured data to the second logic.

Example 8 includes the subject matter of Examples 1 to 7, and optionally the isolation unit comprises an optical coupler.

Example 9 includes the subject matter of Examples 1 to 8, and optionally the isolation unit comprises a magnetic coupler.

Example 10 includes the subject matter of Examples 1 to 9, and optionally the isolation unit comprises an acoustic coupler.

Example 11 includes the subject matter of Examples 1 to 10, and optionally, comprising Registered Jack (RJ)-45 connector.

Example 12 includes a system on chip (SoC) to provide unidirectional secured communication from a secured network to unsecured network, the SoC comprising: circuitry to receive at least one communication from a secured network according to a first communication protocol, wherein the communication includes privileged data; write the privilege data in a memory; convert the privilege data from first parallel data stream to serial data stream and pass the serial data stream through an isolation unit; convert the serial data stream of the privilege data to a second parallel data stream and write the privilege data in a read only memory; apply an unsecured communication protocol to the privilege data; and transmit the privilege data to at least one device of the unsecured network, wherein transmissions of the plurality of devices of the unsecured network terminated by the circuitry.

Example 13 includes the subject matter of Example 1, and optionally the circuitry is to transmit an at least one communication to the at least one device of the unsecured network to terminate connection with the at least on device.

Example 14 includes the subject matter of Examples 12 and 13, and optionally, the circuitry comprises: a protocol convertor unit to covert the first communication protocol to a second communication protocol, the second communication protocol is being selected from at least two or more communication protocols.

Example 15 includes the subject matter of Examples 12 to 14, and optionally, the circuitry comprises: a first logic to process the communications from the secured network; a second logic to communicate with the unsecured network; and a third logic to block communications from the unsecured network and to provide the modified secured data to the second logic.

Example 16 includes the subject matter of Examples 12 to 15, and optionally, the circuitry comprises: a secured unidirectional network adaptor.

Example 17 includes the subject matter of Examples 12 to 16, and optionally, the isolation unit comprises: a unidirectional circuitry to transfer the modified secured data to the second logic.

Example 18 includes the subject matter of Examples 12 to 17, and optionally, isolation unit comprises an optical coupler.

Example 19 includes the subject matter of Examples 12 to 18, and optionally, the isolation unit comprises a magnetic coupler.

Example 20 includes the subject matter of Examples 12 to 19, and optionally, the isolation unit comprises an acoustic coupler.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An apparatus to transfer communications between a secured network and an unsecured network, the apparatus comprising a circuity configured to:
receive an at least one communication from an at least one device of plurality of devices of the secure network over a first communication protocol wherein the at least one communication includes a privilege data;
write the privilege data in a first memory;
convert the privilege data from first parallel data stream to serial data stream and pass the serial data stream through an isolation unit;
convert the serial data stream of the privilege data to a second parallel data stream and write the privilege data in a second memory;
apply an unsecured communication protocol to the privilege data; and
transmit the privilege data to at least one device of the unsecured network, wherein transmissions of the plurality of devices of the unsecured network terminated by the circuitry.

2. The apparatus of claim 1, wherein the circuity is configured to:
prevent access by the plurality of devices of the unsecure network to the first memory,

3. The apparatus of claim 1, wherein the circuitry is configured to:
transmit an at least one communication to the at least one device of the unsecured network to terminate connection with the at least on device.

4. The apparatus of claim 1, wherein the circuitry comprises:
a protocol convertor unit to convert the first communication protocol to a second communication protocol, wherein the second communication protocol is selected from at least two or more communication protocols.

5. The apparatus of claim 1, wherein the circuitry comprises:
a first logic to process the communications from the secured network;
a second logic to communicate with the unsecured network; and
a third logic to physically block data communications from the unsecured network and to provide the modified secured data the second logic.

6. The apparatus of claim 1, wherein the circuitry comprises a secured unidirectional network adaptor.

7. The apparatus of claim 1, wherein the isolation unit comprises a unidirectional circuitry to transfer the modified secured data to the second logic.

8. The apparatus of claim 1, wherein the isolation unit comprises an optical coupler.

9. The apparatus of claim 1, wherein the isolation unit comprises a magnetic coupler.

10. The apparatus of claim 1, wherein the isolation unit comprises an acoustic coupler.

11. The apparatus of claim 1, further comprising Registered Jack (RJ)-45 connector.

12. A non-transitory computer-readable storage medium, comprising a set of instructions that, when executed by circuitry of an apparatus, cause the apparatus to:
receive an at least one communication from an at least one device of plurality of devices of the secure network over a first communication protocol wherein the at least one communication include a privilege data;
write the privilege data in a first memory;
convert the privilege data from first parallel data stream to serial data stream and pass the serial data stream through an isolation unit;
convert the serial data stream of the privilege data to a second parallel data stream and write the privilege data in a second memory;
apply an unsecured communication protocol to the privilege data; and
transmit the privilege data to at least one device of the unsecured network, wherein transmissions of the plurality of devices of the unsecured network terminated by the circuitry.

13. The non-transitory computer-readable storage medium of claim 12, wherein the instructions, when executed, cause the circuitry to:
prevent accessed by the plurality of devices of the unsecure network to the memory.

14. The non-transitory computer-readable storage medium of claim 12, wherein the circuitry comprises:
a protocol convertor unit to covert the first communication protocol to a second communication protocol, the second communication protocol is being selected from at least two or more communication protocols.

15. The non-transitory computer-readable storage medium of claim 12, wherein the circuitry comprises:
a first logic to process the communications from the secured network;
a second logic to communicate with the unsecured network; and
a third logic to block data communications from the unsecured network and to provide the modified secured data to the second logic.

16. The non-transitory computer-readable storage medium of claim 12, wherein the circuitry comprises: a secured unidirectional network adaptor.

17. The non-transitory computer-readable storage medium of claim 12, wherein the isolation unit comprises:
a unidirectional circuitry to transfer the modified secured data to the second logic.

18. The non-transitory computer-readable storage medium of claim 12, wherein the isolation unit comprises an optical coupler.

19. The non-transitory computer-readable storage medium of claim 12, wherein the isolation unit comprises a magnetic coupler.

20. The non-transitory computer-readable storage medium of claim 12, wherein the isolation unit comprises an acoustic coupler.
